(19) United States
(12) Patent Application Publication
(10) Pub. No.: US 2003/0190881 A1
(43) Pub. Date: Oct. 9, 2003

(54) Coin routing plate

(76) Inventors: Brian L. Gailey, San Antonio, TX (US); Stephen D. DeVaney, San Antonio, TX (US)

Correspondence Address: Brian L. Gailey, 6819 Castile de Oro, San Antonio, TX, 78239, US

(21) Appl. No.: 10/115,494

(22) Filed: Apr. 4, 2002

(51) Int. Cl. G07D 9/00

(52) U.S. Cl. 453/63; 453/3

(57) ABSTRACT

An improved coin routing plate made from a solid piece of resilient and rigid material that incorporates a slot in the coin channel that allows access to any coins that are in the plate and also allows coin dust and debris to escape thereby resulting in less jams and expedites the un-jamming process without removing any parts from the hopper mechanism. Constructed in such a manner as to make it highly resistant to bending and warping thereby having the economic advantage of less replacement and less down time to un-jam and maintain.

### BACKGROUND OF THE INVENTION

1. Field of the Invention

The present Invention relates to coin counting and dispensing mechanisms and specifically to an improved coin routing plate for transporting coins from a payout hopper in a gaming device and for minimizing jamming of such mechanisms.

2. Prior Art

Coin counting and dispensing machines are well known in the art. For instance, Brietenstein et al. U.S. Pat. No. 3,942,544 discloses a hopper payout device that can be used for various coin denominations. Paulsen et al. U.S. Pat. No. 4,574,824, discloses an agitator for a coin hopper for improving payout efficiency. Paulsen et al. U.S. Pat. No. 4,592,377 describes a coin escalator for conveying coins discharged by a coin hopper to a higher elevation for discharge in a coin dispensing machine. Applicant incorporates by reference herin each said reference.

Coins and or Tokens are subject to jams for a number of reasons as they exit the coin hopper and are routed to the escalator. The coins and or Tokens will “shingle” when they enter the coin routing plate due to some of the reasons outlined below. Shingling is when the edges of adjacent coins become overlapped, therby wedging in the channel and jamming the device. Another cause of jams is when the coin and or tokens shingle they form a wedge which will flex and bend the coin routing plate. This in turn will make the channel opening to the coin routing plate become larger than the nominal thickness of the coin and or token and will render the plate inoperable and will have to be replaced in order to return the machine to service. Another cause of jams is due to the sliding of the electroplated coins and or tokens. This causes particles of plating and any residual debris (in other words dirt, dust, and oil from handling.) from the surface of the coins and or tokens to accumulate in the channel of the coin routing plate, therby reducing the amount of clearance needed to allow the coin and or token to be directed to the coin escalator. Another cause of jams is due to improper repair of conditions that resulted in the previous jam. (In other words the slot machine maintenance personal often use a screwdriver or similar device to bend or pry the plate away from the mounting surface of the hopper in order to free the jammed coins and place the machine back into service.) However this results in a false economy in that by clearing the jam in this manner results in a bent or warped coin routing plate, which will only jam again, and more often. The proper way to repair the machine once the plate is bent or warped is to disassemble the hopper to the point whereby you can exchange the bent coin routing plate for a new one.

Jamming of the coin hopper is undesirable. Coin counting and dispensing mechanisms are profitable only when they are in active operation and receiving coins. For this reason, payout should be accomplished in as short a time as possible to maximize efficiency. A coin jam requires that the entire mechanism be shut down to permit a technician to gain access to the coin hopper and elevator mechanism to remove the source of the jam. While the source of the jam is being removed, the mechanism is inoperative. In effect costing the operators of the slot machine to lose potential revenue. In the past most coin routing plates were comprised of multiple die stamped pieces that are stacked in a particular order and spot welded or tacked together in such a way as to form the channel that the coins and or tokens travel through from the pinwheel to the escalator chute. The chosen design and construction of the stacked plates makes them weak and very malleable. When parts are made from stacked sheet metal, each piece is individually stamped from different shaped dies. These parts generally have to be made from annealed sheet metal or what is known in the sheet metal trade as one half hard or one quarter hard in order for the dies to stamp such a thin piece sharp and bur free. Then each piece is fusion ark welded or spot welded together in several different locations on the plate. This process further anneals or softens the plate and makes it easier to bend and makes it tend not to hold the originally intended shape. Another shortcoming of the stacked plate design is that the designers and engineers are limited in their choices of sheet metal thick nesses and gauges to those that are made and are available. These sheet metal thick nesses make up the channel depth, which makes the clearance for the coins and or tokens to travel through to the coin routing plate to the escalator. By only being able to choose sizes in stock thickneses they either have to chose to make the coin and or token clearance to narrow or to wide. If the coin and or token clearance is to narrow it will jam quickly due to debris from the coins. If the coin and or token clearance is to wide the coins can easily shingle to form a wedge which will quickly jam and bend or warp the plate to the point of rendering it inoperable and unrepairable. Another shortcoming to this design is that the one half or one quarter hard sheet metal that is used can not generally be drilled and tapped to hold threaded bolts or studs that are required to assemble the coin routing plate and other parts necessary to enable the escalator to operate. The studs and screws have to be spot welded to the coin routing plate. Again this further weakens the plate due to annealing the already annealed sheet metal.

### SUMMARY OF THE INVETION

The principal object of the present invention is to provide an improved coin routing plate that will minimize jams.

It is also an object of the present invention to provide an improved coin routing plate that will render a longer service life requiring less frequent replacement.

It is also an object of the present invention to provide an improved coin routing plate that will have an opening placed in the plate in such a manner as to allow the slot machine technician to unjam the plate without having to disassemble the hopper mechanism.

It is also an object of the present invention to provide an improved coin routing plate that will have an opening placed in the plate in such a manner as to allow loose plating and debris to escape the coin channel.

It is also an object of the present invention to provide an improved coin routing plate that will be made of such a construction as to greatly resist bending and warping.

It is also an object of the present invention to provide an improved coin routing plate that is made of such a construction as to allow replacement of all studs and or bolts attached.

A further object of the present invention is to provide an improved coin routing plate that is inexpensive to manufacture and inexpensive to purchase.

The foregoing objects can be accomplished by providing an improved coin routing plate that is made from a solid and rigid piece of material that has a coin channel machined into the plate surface with openings on two sides to line up with the entry and exit points of the particular coin hopper and escalator. It will also have a curved slot running through the center of the coin channel in the same radius. In the preferred embodiment of the invention the plate will be made of a solid and rigid piece of resilient material that has a channel machined in a curved radius on one side at a depth just slightly larger than the respective coin and or token thickness, with an entry point and exit point to match the coin hopper and coin escalator. The plate will have a slot machined into the center of the channel that will give the technician access to the channel from the outward side of the plate when it is installed in the proper operating position on the coin hopper mechanism. The slot in the plate will be located at a position along the radius of the channel in a position that would best facilitate the release of plating debris and any other undesirable substances that would tend to otherwise accumulate in the bottom of the channel. The plate would have mounting holes in such a pattern and size as to match whatever coin hopper and coin escalator that it is intended for. The plate would be made with an adequate amount of material in the thinnest sections of the plate as to adequately resist bending or warping from forces applied from within or externally. The plate would have holes that are threaded to except any studs or bolts that are necessary to mount the plate in a particular coin hopper or mount any parts that are necessary for the hopper or the escalator to function properly. The plate would have studs or bolts that are removable and replaceable without rendering the plate dysfunctional.

### BRIEF DISCRIPTION OF THE DRAWINGS

FIG. 1 is a front view of a typical prior art coin routing plate.

FIG. 2 is a left and right side view of a typical prior art coin routing plate.

FIG. 3 is a front view of the improved coin routing plate in accordance with the present invention

FIG. 4 is a left and right side view of the improved coin routing plate in accordance with the present invention

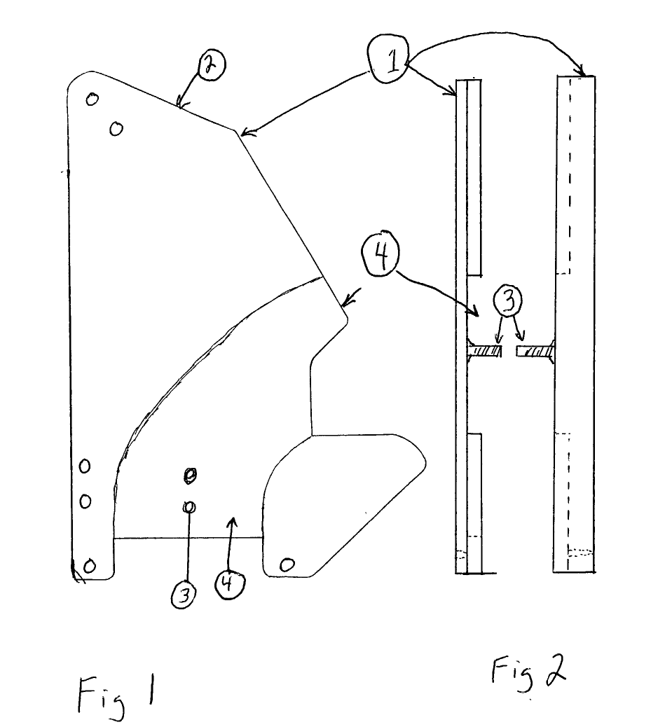

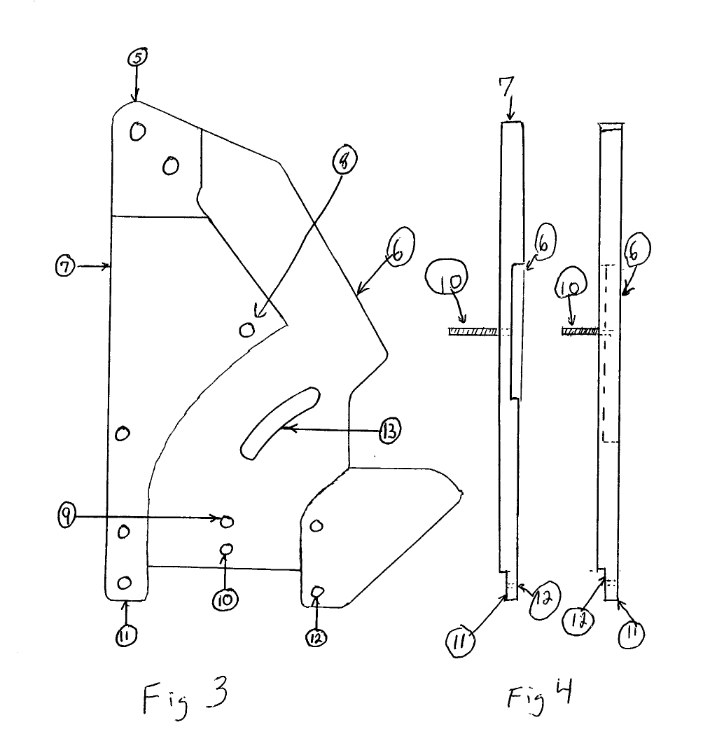

### DETAILED DESCRIPTION

As shown in the drawings the preferred coin routing plate 7 is made of a solid rigid piece of material in the correct size shape and overall thickness as required to fit a particular coin hopper, The plate 7 has material milled from the surface to form a channel 6 the correct depth to allow the coin to travel edge to edge freely but not to deep as to allow the coin to stack or shingle and in a direction for the coin to move from the pinwheel to the coin escalator. The plate7 has holes 8 of the correct size and location to mount to a particular coin hopper that the plate is intended. The plate 7 has holes9 that are drilled and threaded to receive removable studs to support parts of the coin escalator. The plate has material removed on the opposite side 11 to support mounting of the coin escalator. The plate holes 12 the correct size and in the correct location to mount the coin knife in the proper position to ride against the pinwheel and deliver the coin to the coin routing plate. The coin routing plate 7 has a milled through slot 13 that runs along in the same radius as the milled channel 6 in a sufficient length and placement to give access to any coins and or tokens that are inside the coin channel when the plate 7 is installed on an operational coin hopper. The coin routing plate 7 has a milled through slot 13 that runs along in the same radius as the milled coin channel 6 in a sufficient length and placement to allow any coin and or token dust and any other debris to fall out of the plate due to gravity and vibrations of the hopper while operating. The coin routing plate 7 has a sufficient number of holes 9 that are threaded to a sufficient size as to allow the placement of removable and replaceable threaded studs 10 to mount parts that the escalator requires for it's operation.

We claim:

1. A coin routing plate comprising:
a) A plate made of a solid rigid piece of material with material milled from the surface to form a channel to allow coins and or tokens to travel freely edge to edge from the pinwheel to the coin escalator.
b) A plate made of a solid rigid piece of material with material milled from the surface to form a channel to allow coins and or tokens to travel freely edge to edge from the pinwheel to the coin escalator and holes that are drilled and threaded to receive removable studs to support parts of the coin escalator.
c) A plate made of a solid rigid piece of material with material milled from the surface to form a channel to allow coins and or tokens to travel freely edge to edge from the pinwheel to the coin escalator the coin routing plate has a milled through slot that runs along in the same radius as the milled coin channel in a sufficient length and placement to give access to any coins and or tokens that are inside the coin channel when the plate is installed on an operational coin hopper.
d) A plate made of a solid rigid piece of material with material milled from the surface to form a channel to allow coins and or tokens to travel freely edge to edge from the pinwheel to the coin escalator. The coin routing plate has a milled through slot that runs along in the same radius as the milled coin channel in a sufficient length and placement to allow any coin and or token dust and any other debris to fall out when the hopper vibrates as it is operated.
